(19) United States
(12) Patent Application Publication
(10) Pub. No.: US 2020/0104610 A1
(43) Pub. Date: Apr. 2, 2020

(54) TARGET DETECTION DEVICE AND TARGET DETECTION METHOD

(71) Applicants: DENSO TEN Limited, Kobe-shi (JP); Japan Automobile Research Institute, Tokyo (JP)

(72) Inventor: Toshihiro MATSUMOTO, Kobe-shi (JP)

(73) Assignees: DENSO TEN Limited, Kobe-shi (JP); Japan Automobile Research Institute, Tokyo (JP)

(21) Appl. No.: 16/541,527

(22) Filed: Aug. 15, 2019

(30) Foreign Application Priority Data
Sep. 28, 2018 (JP) 2018-183724

(51) Int. Cl. G06K 9/00; G01S 13/93; G01S 13/86; G06T 7/70; G08G 1/16

(52) U.S. Cl. CPC G06K 9/00805; G01S 13/931; G01S 13/867; G06T 2207/30261; G06T 7/70; G08G 1/166; G01S 13/865

(57) ABSTRACT

A target detection device according to an embodiment includes an acquisition unit and a determination unit. The acquisition unit acquires positional data of a target in a plurality of sensors and sensor characteristic data that indicate a positional characteristic of detection accuracy in the plurality of sensors. The determination unit determines identity of a target object that is a detection object in each sensor based on positional data and sensor characteristic data that are acquired by the acquisition unit.

### CROSS-REFERENCE TO RELATED APPLICATION

The present application claims the benefit of priority to Japanese Patent Application No. 2018-183724 filed on Sep. 28, 2018, the entire contents of which are herein incorporated by reference.

### FIELD

A disclosed embodiment relates to a target detection device and a target detection method.

### BACKGROUND

Conventionally, there is a target detection device that executes target detection by, for example, synthesizing a plurality of positional data that are relevant to existence of a target such as a position thereof from a sensor that detects such a target, such as a radar device or a camera. For example, in a case where relative velocities and distances are similar between a plurality of positional data, such a type of a target detection device determines that such a plurality of positional data originate from an identical target (see, for example, Japanese Patent Application Publication No. 2015-060300).

However, in a conventional technique as described above, there is room for improvement in accuracy of detection of a target. For example, deviations of a relative velocity and a distance in respective positional data are not taken into consideration, so that there is room for improvement in determination accuracy as to whether or not to originate from an identical target.

### SUMMARY

A target detection device according to an aspect of an embodiment includes an acquisition unit and an identity determination unit. The acquisition unit acquires positional data of a target in a plurality of sensors and sensor characteristic data that indicate a positional characteristic of detection accuracy in the plurality of sensors. The identity determination unit determines identity of a target object that is a detection object in each sensor based on positional data and sensor characteristic data that are acquired by the acquisition unit.

### BRIEF DESCRIPTION OF DRAWINGS

More complete recognition of the present invention or an advantage involved therewith would readily be understood by reading the following detailed description of the invention in light of the accompanying drawings.

FIG. 1 is a diagram illustrating an outline of a target detection method according to an embodiment.

FIG. 2 is a block diagram illustrating a configuration of a target detection device according to an embodiment.

FIG. 3 is an explanatory diagram for explaining characteristic information.

FIG. 4 is a diagram illustrating a determination process that is executed by a determination unit.

FIG. 5 is a flowchart illustrating process steps of a process that is executed by a target detection device according to an embodiment.

### DESCRIPTION OF EMBODIMENT

Hereinafter, an embodiment of a target detection device and a target detection method as disclosed in the present application will be explained in detail with reference to the accompanying drawings. Additionally, the present invention is not limited by such an embodiment.

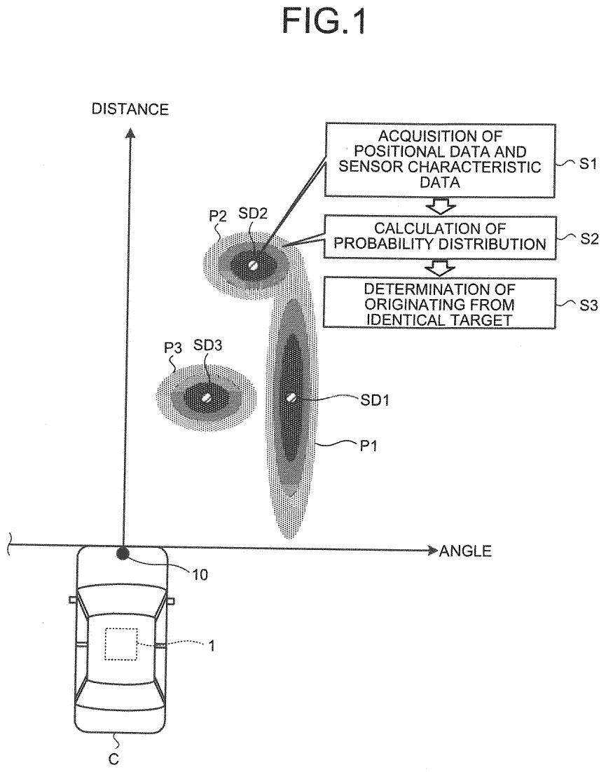

First, an outline of a target detection method according to an embodiment will be explained by using FIG. 1. FIG. 1 is a diagram illustrating an outline of a target detection method according to an embodiment. FIG. 1 illustrates a case where a target detection device 1 according to an embodiment is mounted on a vehicle C. Additionally, an object that mounts the target detection vehicle 1 thereon is not limited to a vehicle C and may be another movable body such as a motorcycle, a car, a ship, or an airplane. Alternatively, a movable body is not limiting and the target detection device 1 may be mounted on, for example, a stationary body such as a street light or a roadside object (such as a guardrail or a traffic light).

Furthermore, as illustrated in FIG. 1, a sensor 10 that detects a target is mounted on a vehicle C. For a type of the sensor 10, for example, a camera, a radar device such as a millimeter-wave one, a Laser Imaging Detection and Ranging (LiDAR), and the like are provided. Additionally, the sensor 10 may be single or may be multiple. For example, a plurality of the sensors 10 with a single type may be mounted or each of the sensors 10 with multiple types may be mounted in a single or multiple manner.

A target detection method according to an embodiment is executed by the target detection device 1. Specifically, a target detection method determines, based on positional data of a target in a plurality of the sensors 10 and sensor characteristic data that indicate a positional characteristic of detection accuracy in the plurality of the sensors 10, identity of a target object that is a detection object in each sensor. Positional data include, for example, positional data that are relevant to a position of a target such as a relative velocity, a distance in a longitudinal direction, an angle, or the like of a target. Furthermore, sensor characteristic data include information that is relevant to a probability distribution of a target object with respect to acquired positional data (probability distribution data), information on reliability in each of different types of a detection value with respect to acquired positional data (reliability data), or the like. In other words, sensor characteristic data are information that indicates how much error is included in positional data of each sensor 10.

Herein, a conventional target detection method will be explained. In a case where relative velocities and distances in a plurality of positional data that are acquired from a sensor are similar, it is conventionally determined that the plurality of positional data originate from an identical target. In a case where positional data in FIG. 1 are provided as an example, it is conventionally determined that positional data SD1 and positional data SD3 where a distance between such positional data is short originate from an identical target.

However, in a conventional technique, for example, deviations of a relative velocity and a distance in positional data are not taken into consideration. For example, a deviation of positional data differs depending on a type of a sensor, so that it may be erroneously determined that positional data that intrinsically originate from different targets originate from an identical target, depending on such a deviation of positional data. Thus, there is room for improvement in accuracy of detection of a target conventionally.

Hence, a target detection method according to an embodiment determines whether or not to originate from an identical target by taking a deviation of positional data (detection accuracy) into consideration. Specifically, the target detection device 1 according to an embodiment, first, acquires positional data of a target and sensor characteristic data in a plurality of the sensors 10 (step S1).

Additionally, FIG. 1 illustrates three positional data SD1 to SD3. Specifically, positional data SD1 are positional data that are generated based on an image that is captured by a camera and positional data SD2, SD3 are positional data that are generated by a radar device.

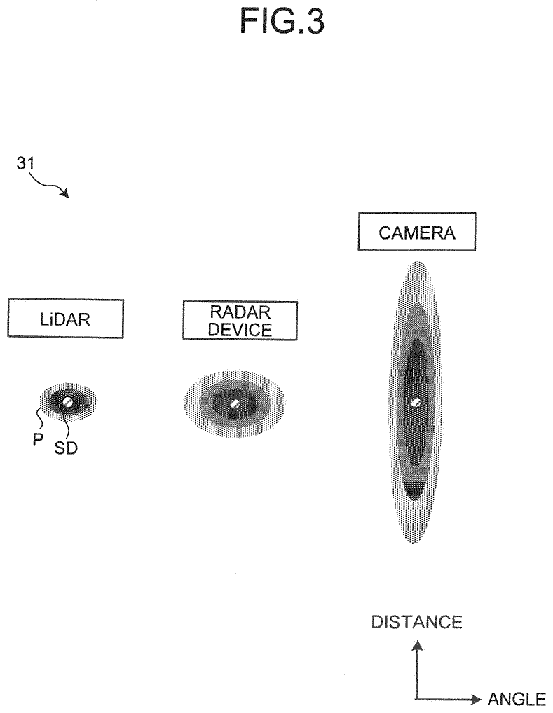

Subsequently, the target detection device 1 according to an embodiment calculates probability distributions P1 to P3 that are relevant to existence of a plurality of acquired positional data SD1 to SD3, respectively (examples of an existence probability distribution) (step S2). For probability distributions P1 to P3, a probability distribution that is dependent on a characteristic of a sensor 10 is calculated. Specifically, probability distributions P1 to P3 are calculated based on positional data and sensor characteristic data. In other words, probability distributions P1 to P3 are error ranges of positional data in each sensor 10. Additionally, a detail of probability distributions P1 to P3 that are dependent on a characteristic of the sensor 10 will be described later in FIG. 3. Additionally, FIG. 1 indicates that a probability is increased with increasing a density of probability distributions P1 to P3.

Subsequently, the target detection device 1 according to an embodiment determines whether or not a plurality of positional data SD1 to SD3 originate from an identical target based on probability distributions P1 to P3 for respective calculated positional data SD1 to SD3 (step S3). That is, the target detection device 1 determines identity of a target object that is a detection object in each sensor, based on acquired positional data and sensor characteristic data.

In an example as illustrated in FIG. 1, a probability distribution P1 of positional data SD1 and a probability distribution P2 of positional data SD2 overlap and the probability distribution P1 of the positional data SD1 and a probability distribution P3 of positional data SD3 do not overlap.

In other words, in a case where deviations of positional data SD1 to SD3 are taken into consideration, there is a possibility that positional data SD1 and positional data SD2 overlap depending on deviations thereof, that is, there is a high possibility that they originate from an identical target. On the other hand, there is no possibility that positional data SD1 and positional data SD3 overlap, that is, there is a low possibility that they originate from an identical target.

Therefore, the target detection device 1 according to an embodiment, in an identity determination process, determines that positional data D1 and positional data SD2 originate from an identical target and determines that the positional data SD1 and positional data SD3 originate from different targets. That is, the target detection device 1 determines that positional data SD1 and positional data SD2 are of an identical target and determines that the positional data SD1 and positional data SD3 are not of an identical target.

Thus, probability distributions that are relevant to existence of positional data SD1 to SD3 (a distance and an angle in FIG. 1) are calculated based on sensor characteristic data, so that it is possible to improve determination accuracy as to whether or not a plurality of positional data SD1 to SD3 originate from an identical target. Therefore, in a target detection method according to an embodiment, determination of identity is executed based on positional data and sensor characteristic data, so that it is possible to improve accuracy of detection of a target.

Additionally, the target detection device 1 according to an embodiment calculates a similarity among positional data SD1 to SD3 and executes determination as to whether or not a plurality of positional data SD1 to SD3 originate from an identical target by using a similarity that is corrected based on probability distributions P1 to P3, where such a matter will be described later.

Additionally, in a case where positional data SD1 to SD3 and probability distributions P1 to P3 are not particularly distinguished, positional data SD and a probability distribution P may be described below.

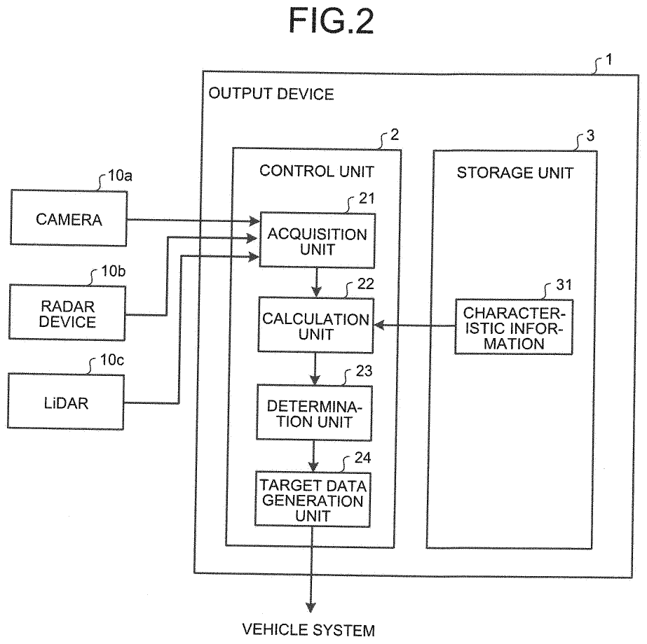

Next, a configuration of the target detection device 1 according to an embodiment will be explained in detail with reference to FIG. 2. FIG. 2 is a block diagram illustrating a configuration of the target detection device 1 according to an embodiment. As illustrated in FIG. 2, the target detection device 1 according to an embodiment is connected to a camera 10a, a radar device 10b, and a LiDAR 10c. The camera 10a, the radar device 10b, and the LiDAR 10c are specific examples of the sensor 10 as described above.

The camera 10a is an image-capturing device that captures an image of an outside situation of a vehicle C. For example, the camera 10a is provided on a windshield of a vehicle C and captures an image of a front side of the vehicle C. Additionally, the camera 10a may be provided at a position where an image of a left or right side of a vehicle C is captured and a position where an image of a rear side of the vehicle C is captured.

The radar device 10b detects a target on a periphery of a vehicle C by utilizing a radio wave such as a millimeter wave. Specifically, the radar device 10b transmits a radio wave to a periphery of a vehicle C and receives a reflected wave that is reflected from a target, so that such a target is detected.

The LiDAR 10c detects a target on a periphery of a vehicle C by utilizing laser light. Specifically, the LiDAR 10c transmits laser light to a periphery of a vehicle C and receives reflected light that is reflected from a target, so that such a target is detected.

The target detection device 1 according to an embodiment includes a control unit 2 and a storage unit 3. The control unit 2 includes an acquisition unit 21, a calculation unit 22, a determination unit 23, and a target data generation unit 24. The storage unit 3 stores characteristic information 31 therein.

Herein, the target detection device 1 includes, for example, a computer that has a Central Processing Unit (CPU), a Read Only Memory (ROM), a Random Access Memory (RAM), a Data Flash, an input/output port, and the like, and a variety of circuits.

For example, a CPU of a computer reads and executes a program that is stored in a ROM so as to function as the acquisition unit 21, the calculation unit 22, the determination unit 23 (an example of an identity determination unit), and the target data generation unit 24 of the control unit 2.

Furthermore, it is also possible to provide at least one or all of the acquisition unit 21, the calculation unit 22, the determination unit 23, and the target data generation unit 24 of the control unit 2 that are composed of hardware such as an Application Specific Integrated Circuit (ASIC) or a Field Programmable Gate Array (FPGA).

Furthermore, the storage unit 3 corresponds to, for example, a RAM or a Data Flash. It is possible for a RAM or a Data Flash to store the characteristic information 31, information of a variety of programs, and the like. Additionally, the target detection device 1 may acquire a program as described above or a variety of information through another computer that is connected by a wired or wireless network or a portable recording medium.

The control unit 2 acquires positional data SD and sensor characteristic data in the sensor 10, calculates a probability distribution P of acquired positional data SD, and determines whether or not a plurality of positional data SD originate from an identical target, based on calculated probability distributions of respective positional data SD. Furthermore, the control unit 2 executes a process of generating a target data based on positional data SD.

The acquisition unit 21 acquires a plurality of positional data SD that are relevant to existence of a target from the sensors 10 such as the camera 10a, the radar device 10b, and the LiDAR 10c. Positional data SD include, for example, positional information that is relevant to a position of a target or information of a relative velocity with respect to a vehicle C or the like, as information that is relevant to existence of a target. Positional information includes, for example, information such as a distance to a target in a longitudinal direction (a through direction), an angle (an orientation viewed from a vehicle C), or a relative velocity with respect to a vehicle C. Additionally, a plurality of positional data SD in each sensor 10 may be obtained from one target.

For example, in a case of the camera 10a, positional data SD include information such as a shape of a target, a color of a target, a type of a target, or a position (a distance, an angle, or the like) of a target as information of a target that is detected by image processing. Furthermore, positional data SD of the camera 10a may include information of a relative velocity or a movement direction of a target that is calculated based on time-series images.

Furthermore, in a case of the radar device 10b, positional data SD include information such as a distance, an angle, or a relative velocity of a target. Additionally, positional data SD of the radar device 10b may include information of a peak in a frequency spectrum that is obtained by two-dimensional-first-Fourier-transforming a beat signal. Additionally, positional data SD of the radar device 10b may be information of a plurality of reflection points that are obtained from one target.

Furthermore, in a case of the LiDAR 10c, positional data SD include information such as a distance, an angle, or a relative velocity of a target. Additionally, positional data SD of the LiDAR 10c may be information of a plurality of reflection points that are obtained from one target.

Additionally, the acquisition unit 21 may acquire positional data SD that include information of a distance, an angle, or a relative velocity of a target from each sensor 10 as described above or may acquire a detection signal of the sensor 10 and calculate a distance, an angle, or a relative velocity of a target based on such a detection signal to provide positional data SD.

The calculation unit 22 calculates a probability distribution that is relevant to existence of each of a plurality of positional data SD that are acquired by the acquisition unit 21. Specifically, the calculation unit 22 calculates a probability distribution P of a target that is based on positional data of each sensor 10, from acquired positional data and probability distribution data. More specifically, the calculation unit 22 calculates a probability distribution of each of positional data SD based on the characteristic information 31 that is stored in the storage unit 3. The characteristic information 31 is information that includes sensor characteristic data, more particularly, is information that stores probability distribution data that are dependent on a characteristic of the sensor 10.

Herein, the characteristic information 31 will be explained by using FIG. 3. FIG. 3 is an explanatory diagram for explaining the characteristic information 31. FIG. 3 schematically illustrates information of a probability distribution P that is included in the characteristic information 31.

As illustrated in FIG. 3, the characteristic information 31 includes information of a probability distribution P for each type of the sensor 10 (probability distribution data). For example, information of a probability distribution P is a probability distribution function that is represented by a two-dimensional normal distribution of a distance to a target in a longitudinal direction and an angle thereof.

Then, information of a probability distribution P is of a distribution profile that differs depending on a characteristic of the sensor 10. For example, a probability distribution P of the LiDAR 10c is provided in such a manner that a planar shape with axes that are a distance and an angle is an elliptical shape and a length in an angle direction is greater than that in a distance direction. Furthermore, a probability distribution P of the LiDAR 10c is provided in such a manner that a planar shape is narrowest among those of probability distributions P of the three sensors 10. That is, the LiDAR 10c among the three sensors 10 has a characteristic with a minimum deviation of positional data SD.

Furthermore, a probability distribution P of the radar device 10b that utilizes a millimeter wave is of an elliptical shape where a length in an angle direction is greater than that in a distance direction and a planar shape is greater than that of the LiDAR 10c. That is, the radar device 10b has a characteristic with a deviation of positional data SD that is greater than that of the LiDAR 10c.

Furthermore, a probability distribution P of the camera 10a is of an elliptical shape where a length in a distance direction is extremely greater than that in an angle direction. That is, positional data SD of the camera 10a has a characteristic with a deviation in a distance direction that is extremely greater than that of an angle direction. This is because, in a case where a distance is represented by one pixel in an image of the camera 10a, a distance that is represented by one pixel for a pixel at a long distance is greater than that for a pixel at a short distance.

Thus, the camera 10a, the radar device 10b, and the LiDAR 10c calculate probability distributions P that correspond to respective characteristics, so that it is possible to improve determination accuracy in the determination unit 23 at a subsequent stage.

For example, the calculation unit 22 plots acquired positional data SD on a plane with axes that are a distance and an angle and sets a probability distribution P of the characteristic information 31 in the positional data SD. Thus, a probability distribution P that is relevant to a position of a target, that is, a probability distribution P that is relevant to a distance and an angle of a target, is calculated, so that it is possible to improve determination accuracy in the determination unit 23 at a subsequent stage.

Additionally, the calculation unit 22 may default a probability distribution P of the characteristic information 31 and further input another information thereto so as to deform a default probability distribution P. For example, the calculation unit 22 may deform a probability distribution P depending on each detection value (positional information, a relative velocity, or the like) that is included in positional data.

Furthermore, although a probability distribution P is represented as a two-dimensional normal distribution of a distance and an angle, it may be represented by a three-or-more-dimensional normal distribution that includes, for example, a relative velocity of a target, a height of a target, or the like, other than a distance and an angle. Furthermore, a probability distribution P is not limited to a normal distribution and it is possible to employ any distribution profile.

Furthermore, for a probability distribution P, for example, probability distribution data for each sensor may preliminarily be measured or calculated by an experiment or the like and stored in the storage unit 3 or the like, so as to read and directly utilize corresponding probability distribution data from the storage unit 3, at a time of use of such probability distribution data.

The determination unit 23 determines identity of a target object that is a detection object in each sensor, based on positional data and sensor characteristic data that are acquired by the acquisition unit 21. Specifically, the determination unit 23 determines whether or not a plurality of positional data originate from an identical target, based on a probability distribution P that is relevant to existence of a target for each of a plurality of positional data SD that are calculated by the calculation unit 22. For example, the determination unit 23 determines whether or not a plurality of positional data SD originate from an identical target, based on a probability distribution P that is relevant to a position (a distance and an angle) of a target.

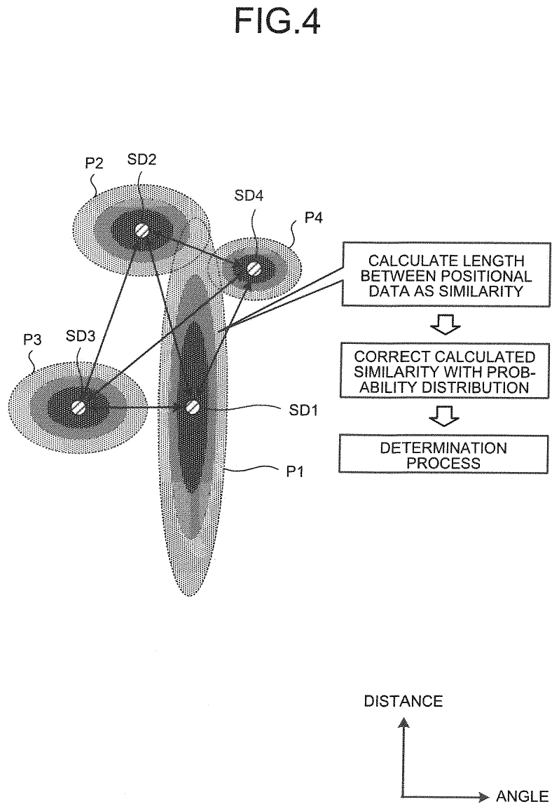

For example, the determination unit 23 calculates a similarity between a plurality of positional data SD based on positional data SD and a probability distribution of such positional data SD and determines whether or not such a plurality of positional data SD originate from an identical target based on a calculated similarity. Such a matter will be explained by using FIG. 4.

FIG. 4 is a diagram illustrating a determination process that is executed by the determination unit 23. FIG. 4 explains a determination process for four positional data SD1 to SD4. Furthermore, FIG. 4 illustrates positional data SD1 and a probability distribution P1 of the camera 10a, positional data SD2, SD3 and probability distributions P2, P3 of the radar device 10b, and positional data SD4 and a probability distribution P4 of the LiDAR 10c.

First, the determination unit 23 calculates, as a similarity, a length between two positional data SD for any combination of a plurality of positional data SD1 to SD4. It is possible to calculate a length between positional data SD as, for example, a Euclidean distance. For example, in a case where a Euclidean distance is short, a similarity is high, that is, two positional data SD are similar.

Subsequently, the determination unit 23 corrects a calculated similarity with a probability distribution. For example, the determination unit 23 multiplies a similarity by a coefficient that is dependent on an overlap between probability distributions P in two positional data SD to execute such correction. Specifically, the determination unit 23 multiplies it by a coefficient in such a manner that a similarity after correction is increased with increasing an overlap between probability distributions P. That is, the determination unit 23 determines identity of a target object by a degree of correlation (a degree of overlap) between probability distributions P.

Additionally, in a case where probability distributions P in two positional data SD do not overlap (do not correlate), correction of a similarity is not executed. Alternatively, in a case where probability distributions P in two positional data SD do not overlap, a similarity may be deleted so as not to be used in a determination process at a subsequent stage.

Subsequently, the determination unit 23 executes a determination process as to whether or not two positional data SD originate from an identical target based on a similarity after correction. For example, the determination unit 23 determines originating from an identical target in a case where a similarity is a predetermined value or greater.

Additionally, it is also possible to calculate a degree of overlap between probability distributions P (a degree of correlation of each probability distribution) by the following method. First, probability distribution data for each sensor are stored in the storage unit 3 in a form where a probability value is applied to each mesh-like divided region. Then, probability distribution data are applied to positional data of a target object that is detected by each sensor to form each mesh-like probability distribution.

Then, probability values of two positional data are integrated for each mesh region and a sum of integration values for all mesh regions (where, preferably, an effective region is set appropriately) is calculated to provide a degree of correlation that indicates a correlation therebetween.

Then, for positional data of a target in all sensors, a set of two positional data is formed, and for all of such combinations, a degree of correlation is obtained by a process as described above. Then, such a degree of correlation is used for an identical target detection determination process.

Furthermore, as illustrated in FIG. 4, in a case where it is possible to treat sensor characteristic data for respective axes as respectively independent normal distributions, it is also possible to obtain a degree of correlation analytically by using a formula. For example, like FIG. 4, a case is provided where a probability distribution of positional data SD in a distance direction and a probability distribution of positional data SD in an angle direction do not have correlation.

In such a case, in particular, in a two-dimensional case, a shape of a probability distribution is an elliptical shape with a long axis along a distance direction or an angle direction or a perfectly circular shape, as illustrated in FIG. 4. Herein, it is possible to calculate a two-dimensional probability distribution as a product of both one-dimensional normal distributions in respective directions. Therefore, it is also possible to represent a degree of correlation as a product of both degrees of correlation of one-dimensional normal distributions in respective directions. It is possible to calculate a degree of correlation R of one-dimensional normal distributions by formula (1) where standard deviations of two normal distributions are provided as σₐ and σ_{b}, respectively and a difference between both averages of distributions is provided as Δ.

$$R ( △ ) = \frac{1}{\sqrt{2 π ( {σ}_{a}^{2} + {σ}_{b}^{2} )}} exp ( \frac{{△}^{2} {σ}_{a}^{2} - {△}^{2} ( {σ}_{a}^{2} + {σ}_{b}^{2} )}{2 {σ}_{b}^{2} ( {σ}_{a}^{2} + {σ}_{b}^{2} )} ) \qquad ( 1 )$$

Therefore, it is possible to obtain a degree of correlation Rsd for two positional data SD by substituting sensor information for each direction (in two positional data, a standard deviation for one sensor and a standard deviation of another sensor) and a position difference for each direction into formula (1) to obtain degrees of correlation for respective directions and finally taking a product of both degrees of correlation for respective directions.

For example, in a case of FIG. 4, a degree of correlation Rr in a distance direction is calculated by substituting sensor information in a distance direction into σₐ and σ_{b} and a position difference into Δ in formula (1). Similarly, a degree of correlation Ra in an angle direction is calculated from sensor information in an angle direction and a position difference. Finally, a degree of correlation Rsd is preferably calculated as Rsd=Rr×Ra.

Thereby, a sum of integration values for mesh regions does not have to be calculated so that it is possible to attain reduction of an amount of calculation. Furthermore, it is also possible to attain reduction of an area of memory for holding meth regions. It is possible to obtain such an effect significantly, in particular, in a case where a high-dimensional probability distribution is provided.

In a mesh case, as a dimension of a sensor (two dimensional, that is, a distance and an angle, in FIG. 4) is increased, computation time and an amount of memory are increased exponentially. (division number)\hat{ }(dimension) cycles of taking a sum of products is needed. For example, in a case of 20 mesh divisions, 20 cycles for one dimension, 400 cycles for two dimensions, and 8000 cycles for three dimensions are provided, so that a load is drastically increased. For an analytic formula, a (dimension) cycle(s) of calculation is/are executed. For example, even for three dimensions, merely three cycles of calculation are executed.

Then, in an example as illustrated in FIG. 4, the determination unit 23 determines that positional data SD1 and positional data SD2 or positional data SD1 and positional data SD4 originate from an identical target. Additionally, in a case where positional data SD1 are provided as a reference, determination may be provided in such a manner that only one of positional data SD2 and positional data SD4 (for example, positional data SD1 with a high similarity) originates from an identical target or determination may be provided in such a manner that both the positional data SD2 and the positional data SD4 originate from an identical target.

Thus, for two positional data SD, a determination process is executed by using a similarity that is calculated by taking a probability distribution P into consideration, so that it is possible to improve accuracy of such a determination process.

Additionally, although a case where the determination unit 23 executes a process of correcting a calculated similarity is explained in FIG. 4, for example, a similarity with a probability distribution that is added as a variable may be calculated.

Furthermore, the determination unit 23 is not limited to a case where a determination process is executed based on a similarity, and determination may be executed, for example, in such a manner that positional data SD with overlapping probability distributions P originate from an identical target.

Furthermore, for another example other than a determination method that is based on a probability distribution P, a determination method that is based on, for example, a difference of detection accuracy dependent on a type of a detection value of positional data (such as a distance and an angle or a longitudinal direction and a transverse direction) is also conceivable. In such a case, sensor characteristic data are respective reliability data in different types of a detection value for positional data. Specifically, first, each correction coefficient is set depending on a difference in detection accuracy (reliability) between a distance and an angle in each of positional data.

Then, a difference between respective detection values (a distance and an angle) for two positional data is integrated with a correction coefficient so as to calculate a total thereof. A method is conceivable where such a calculation process is executed for any combination of two positional data among all positional data in a sensor and whether or not to be based on an identical target is executed by comparison between calculated totals (for example, determination is provided in such a manner that ones with a total value that is a predetermined value or less originate from an identical target). Simply, such a determination is also possible (suitable for a preliminary process with accuracy that is less needed or the like).

Furthermore, for timing of a determination process that is executed by the determination unit 23, a determination process may be executed at timing when all positional data SD in a plurality of sensors 10 are collected, or in a case where timing of acquisition of positional data SD is different between respective sensors 10, a determination process may be executed at timing when positional data SD of one or a predetermined number of the sensors 10 among a plurality of the sensors 10 are acquired.

The target data generation unit 24 generates target data for each target based on a result of determination of the determination unit 23. For example, for a plurality of positional data SD that are determined to originate from an identical target by the determination unit 23, the target data generation unit 24 generates a representative value of such a plurality of positional data SD as target data.

For example, the target data generation unit 24 provides an average value of a plurality of positional data SD as a representative value. Alternatively, the target data generation unit 24 multiplies an average value by a coefficient that is dependent on an overlap between probability distributions in a plurality of positional data SD so as to provide a representative value.

Alternatively, the target data generation unit 24 may generate, as target data, each of a plurality of positional data SD that are provided with a flag that indicates originating from an identical target.

Furthermore, for a plurality of positional data SD that are determined not to originate from an identical target, that is, determined to originate from different targets, by the determination unit 23, the target data generation unit 24 generates target data for each of a plurality of positional data SD.

The target data generation unit 24 outputs generated target data to, for example, a vehicle system such as an automatic operating system.

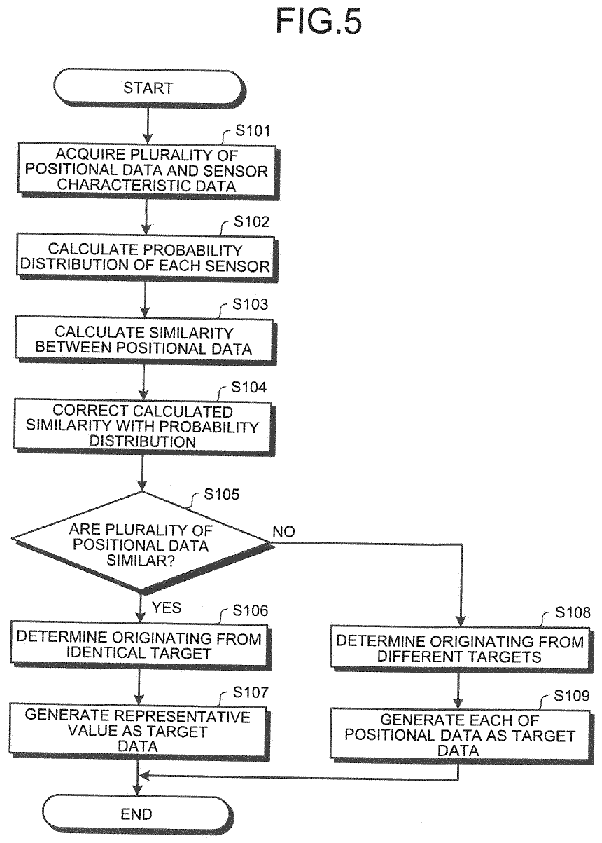

Next, process steps of a process that is executed by the target detection device 1 according to an embodiment will be explained by using FIG. 5. FIG. 5 is a flowchart illustrating process steps of a process that is executed by the target detection device 1 according to an embodiment.

As illustrated in FIG. 5, first, the acquisition unit 21 acquires a plurality of positional data SD that are relevant to existence of a target in the sensor 10 that detects a target and sensor characteristic data (step S101).

Subsequently, the calculation unit 22 calculates a probability distribution P that is based on positional data of each sensor 10 from a plurality of positional data SD and sensor characteristic data that are acquired by the acquisition unit 21 (step S102).

Subsequently, the determination unit 23 calculates a similarity between a plurality of positional data (step S103).

Subsequently, the determination unit 23 corrects a calculated similarity with a probability distribution P (step S104).

Subsequently, the determination unit 23 determines whether or not a plurality of positional data SD are similar based on a corrected similarity (step S105).

In a case where a plurality of positional data SD are similar (step S105, Yes), the determination unit 23 determines that the plurality of positional data SD originate from an identical target (step S106).

Subsequently, the target data generation unit 24 generates a representative value of a plurality of positional data SD as target data (step S107) and ends such a process.

On the other hand, in a case where a plurality of positional data SD are not similar at step S105 (step S105, No), the determination unit 23 determines that the plurality of positional data SD originate from different targets (step S108).

Subsequently, the target data generation unit 24 generates each of a plurality of positional data SD as target data (step S109) and ends such a process.

As described above, the target detection device 1 according to an embodiment includes the acquisition unit 21 and the determination unit 23. The acquisition unit 21 acquires positional data of a target in a plurality of the sensors 10 and sensor characteristic data that indicate positional characteristic of detection accuracy in the plurality of the sensors 10. The determination unit 23 determines identity of a target object that is a detection object in each sensor 10 based on the positional data and the sensor characteristic data that are acquired by the acquisition unit 21. Thereby, it is possible to improve accuracy of detection of a target.

Additionally, although a case where target data are generated from positional data SD based on a result of determination of the determination unit 23 is illustrated in an embodiment as described above, the target detection device 1 may output, for example, such a result of determination of the determination unit 23, that is, a result of determination that indicates whether or not a plurality of positional data SD originate from an identical target, to a vehicle system or the like.

According to an aspect of an embodiment, it is possible to improve accuracy of detection of a target.

An additional effect or variation can readily be derived by a person skilled in the art. Hence, a broader aspect of the present invention is not limited to specific details and representative embodiments as illustrated and described above. Therefore, various modifications are possible without departing from the spirit or scope of the general inventive concept as defined by the appended claims and equivalents thereof.

What is claimed is:

1. A target detection device, comprising:
an acquisition unit that acquires positional data of a target in a plurality of sensors and sensor characteristic data that indicate a positional characteristic of detection accuracy in the plurality of sensors; and
an identity determination unit that determines identity of a target object that is a detection object in each sensor based on positional data and sensor characteristic data that are acquired by the acquisition unit.

2. The target detection device according to claim 1, wherein sensor characteristic data that are acquired by the acquisition unit are probability distribution data of a target object with respect to acquired positional data.

3. The target detection device according to claim 2, further comprising:
a calculation unit that calculates an existence probability distribution of a target that is based on positional data of each sensor from positional data of each sensor that are acquired by the acquisition unit and the probability distribution data, wherein
the identity determination unit determines identity of a target object that is a detection object of each sensor from a degree of correlation of an existence probability distribution that corresponds to each sensor that is calculated by the calculation unit.

4. The target detection device according to claim 1, wherein sensor characteristic data that are acquired by the acquisition unit are respective reliability data in different types of a detection value with respect to acquired positional data.

5. A target detection method, comprising:
an acquisition step that acquires positional data of a target in a plurality of sensors and sensor characteristic data that indicate a positional characteristic of detection accuracy in the plurality of sensors; and
an identity determination step that determines identity of a target object that is a detection object in each sensor based on positional data and sensor characteristic data that are acquired by the acquisition step.
